(19) United States
(12) Patent Application Publication
(10) Pub. No.: US 2024/0067787 A1
(43) Pub. Date: Feb. 29, 2024

(54) IMPROVED SURFACE MODIFICATION OF MATERIALS

(71) Applicant: Hitoshi KANAZAWA, Fukushima (JP)

(72) Inventor: Hitoshi KANAZAWA, Fukushima (JP)

(21) Appl. No.: 18/261,258

(22) PCT Filed: Mar. 17, 2021
(86) PCT No.: PCT/JP2021/010870

§ 371 Date: Jul. 12, 2023

(30) Foreign Application Priority Data
Jan. 15, 2021 (JP) 2021-005160

(51) Int. Cl. C08J 7/12; C08J 5/12; C08J 7/056

(52) U.S. Cl. CPC C08J 7/12; C08J 5/12; C08J 7/056

(57) ABSTRACT

The present disclosure provides for improved material surface modification. In one aspect, the present disclosure provides a method of surface modifying a material, the method comprising the steps of (1) oxidizing the material such that the oxidation level of the surface of the material is in a specific numerical range when measured by X-ray photoelectron spectroscopy (XPS), (2) (A) grafting the oxidized material and/or (B) coating the oxidized material with a hydrophilic polymer. In one aspect, the present disclosure provides a method of producing a fiber composite material in which the fiber material is contained within the second material, the method comprising the steps of (1) oxidizing at least one of the fiber material and the second material, (2) interface adhering or bonding the fiber material and the second material after the oxidizing step (3) melting the second material to obtain the fiber composite material.

### TECHNICAL FIELD

This disclosure relates to the surface modification of improved materials. In particular, the present disclosure provides the surface modification method of materials, and the making method of bonded materials or composite materials by improving interfacial adhesion or bonding, and the surface modified materials, bonded materials and composite materials made in such a manner. In particular, the present disclosure provides for strong fiber composite materials.

### BACKGROUND ART

Adhesive materials or composite materials formed by integrating different materials are used in various products such as automotive parts, aircraft parts, medical devices, and electronic devices (e.g., International Laid-Open Patent Publication No. 2005/075190). The strength of adhesive or composite materials may be insufficient, especially at interfaces between different materials, which may limit the use of adhesive or composite materials. Therefore, it is desirable to improve the bonding strength between different materials.

### PRIOR ART LITERATURE

### Patent Literature

[Patent Document 1] International Laid-Open Patent Publication No. 2005/075190

### SUMMARY OF THE INVENTION

### Means of Solving the Problem

The inventor has found suitable conditions for surface modification of materials. The inventor has also discovered a method to perform the strong adhesion of dissimilar materials. Furthermore, the inventor has made adhesive materials and composite materials with unprecedented high strength. Based on these findings, the present disclosure provides the surface modification method of materials, and the making method of bonded materials or composite materials by improving interfacial adhesion or bonding and the surface modified materials, adhesive materials and composite materials made in such a manner.

Thus, this disclosure provides the following.

(Item 1) A method for surface modifying a material, comprising,
(1) the step of oxidizing said material, and
(2) the step of surface coating said oxidation treated material;
the method, wherein said oxidation treatment includes the steps of,
(i) the oxidation treatment is performed such that the (C—O bonds)/(total carbon bonds) % within a depth of 10 nm of the surface of said material as measured by X-ray photoelectron spectroscopy (XPS) increases by about 1 to 20% from before the oxidation treatment, or
(ii) the oxidation treatment is performed so that the percentage of (C—O bonds)/(total carbon bonds) within a depth of 10 nm of the surface of said material, as measured by X-ray photoelectron spectroscopy (XPS), is about 5-15%,
(iii) the method is performed such that the O/C atomic number ratio within a depth of 10 nm of the surface of said material as measured by X-ray photoelectron spectroscopy (XPS) is about 0.03 to 0.2. The method according to Item 1, wherein the step of oxidation treatment of said material is carried out such that the (C—O bonds)/(total carbon bonds) % within a depth of 10 nm of the surface of said material increases by about 1.5 to 15% from before the oxidation treatment when measured by X-ray photoelectron spectroscopy (XPS).

(Item 2) The method according to item 1, wherein the step of oxidizing said material is performed such that the (C—O bonds)/(total carbon bonds) % within a depth of 10 nm of the surface of said material, as measured by X-ray photoelectron spectroscopy (XPS), increases by about 1.5-15% from before the oxidation treatment.

(Item 3) The method according to item 1, wherein the step of oxidation treatment of the material is carried out such that the (C—O bonds)/(total carbon bonds) % within a depth of 10 nm of the surface of the material, as measured by X-ray photoelectron spectroscopy (XPS), is about 5-15%.

(Item 4) The method according to item 1, wherein the step of oxidation treatment of the material is carried out such that the (C—O bonds)/(total carbon bonds) % within a depth of 10 nm of the surface of the material, as measured by X-ray photoelectron spectroscopy (XPS), is about 5-15%.

(Item 5) The method according to item 1, wherein the step of oxidation treatment of said material is performed such that the O/C atomic number ratio within a depth of 10 nm of the surface of said material is about 0.03 to 0.2 when measured by X-ray photoelectron spectroscopy (XPS).

(Item 6) The method for producing an adhesive material, comprising the step of surface modifying said material by the method of any one of Items 1 to 5 and the step of interfacially adhering or bonding said material to the second material.

(Item 7) The method according to item 6, wherein said step of interfacial adhesion or bonding is carried out under conditions wherein an adhesive is present between said material and the second material.

(Item 8) The method according to item 6 or item 7, wherein the step of interfacial adhesion or bonding the material and the second material is carried out, after about 1 hour has elapsed from the step of surface modifying the material.

(Item 9) The method according in any one of items 6 to 8, wherein compared to adhesive materials made from materials prepared under the same conditions except without the step of oxidation treatment described above, it results in an improvement in shear strength of 200 N or more, when the tensile test of a specimen of said surface-modified material of 10 mm width and 1 mm thickness bonded to an aluminum plate of 0.2 mm thickness so that the bonded area is 10 mm×10 mm, at a speed of 20 mm/min and a distance of 60 mm between support points.

(Item 10) A method for producing a fiber composite material wherein the fiber material is contained within the second material, comprising,
(1) the step of oxidizing at least one of the fiber material and the second material, and
(2) interfacially adhering or bonding said fiber material and said second material after said oxidation treatment step,
(3) melting said second material to obtain said fiber composite material.

(Item 11) The method according to item 10, wherein said second material is a resin material.

(Item 12) The method according to items 10 or 11, wherein a specimen of said fiber composite material 80 mm long, 10 mm wide, and 2 mm thick, when subjected to a three-point bend test at a speed of 2 mm/min and a distance between support points of 40 mm, results in a bending strength 1.2 times greater than that of a fiber composite material prepared under the identical conditions except without said step of oxidation treatment.

(Item 13) The method according to items 10 to 12, wherein said oxidation treatment is,
(i) performed such that the percent (C—O bonds)/(total carbon bonds) within a depth of 10 nm of the surface of said material, as measured by X-ray photoelectron spectroscopy (XPS), increases by about 1 to 20% from before the oxidation treatment; or
(ii) performed so that the percentage of (C—O bonds)/(total carbon bonds) within a depth of 10 nm of the surface of said material, as measured by X-ray photoelectron spectroscopy (XPS), is about 5-15%, or
(iii) performed such that the O/C atomic number ratio within a depth of 10 nm of the surface of said material when measured by X-ray photoelectron spectroscopy (XPS) is about 0.03 to 0.2.

(Item 14) The method according to any one of Items 10-13, wherein the weight percentage of the fiber material in the fiber composite material is about 30% or less.

(Item 15) The method according to any one of Items 1 to 14, comprising the step of washing the material to be oxidized prior to said step of oxidation treatment.

(Item 16) The method according to any one of Items 1 to 15, wherein said step of oxidizing includes oxidizing by a treatment selected from the group consisting of plasma treatment, ozone treatment, UV irradiation treatment, corona discharge treatment, high pressure discharge treatment and chemical oxidation.

(Item 17) The method according to items 1 to 16, wherein said step of surface coating the oxidized material comprises,
(a) grafting a hydrophilic vinyl monomer.
(b) grafting a hydrophilic monomer and coating a hydrophilic polymer, or
(c) grafting the vinyl ester monomer and subjecting the material to hydrolysis.

(Item 18) The method according to any one of Items 1 to 17, wherein the increase in weight of the oxidation treated material by the step of surface coating is less than about 5%.

(Item 19) A surface modified material produced by the method of any one of items 1 to 5.

(Item 20) An adhesive material or fiber composite material produced by the method of any one of items 6 to 18.

(Item 21) The fiber composite material according to item 20, wherein the fiber composite material is not cut at the breaking point when evaluated by a three-point bending test on a specimen 80 mm long, 10 mm wide, and 2 mm thick at a speed of 2 mm/min and a distance of 40 mm between support points.

(Item 22) An adhesive material having an interface adhesion or bonding between a first material and the second material, wherein, a fiber composite material having an interface adhesion or bonding between the first material and the second material, wherein the cut surface of at least one of the first material side half material and the second material side half material obtained by cutting the adhesive material along the interface between the first material and the second material has (C—O bonds)/(total carbon bonds) % within 10 nm depth of the material surface when measured by x-ray photoelectron spectroscopy (XPS) is about 5-15%.

(Item 23) A fiber composite material that does not break at the breaking point when evaluated by a three-point bending test on a specimen 80 mm long, 10 mm wide, and 2 mm thick at a speed of 2 mm/min and a distance of 40 mm between support points.

(Item 24]) The fiber composite material according to items 20, 21 or 23, wherein the weight percentage of the fiber material in the fiber composite material is about 30% or less.

In this disclosure, it is intended that one or more of the above features may be provided in further combinations in addition to the explicitly stated combinations. Still further embodiments and advantages of the present disclosure will be recognized by those skilled in the art upon reading and understanding the following detailed description as necessary.

### Advantageous Effect of Invention

The present disclosure provides high-strength adhesive or composite materials. The present disclosure provides high-strength adhesive or composite materials.

### BRIEF DESCRIPTION OF DRAWINGS

FIG. 1 FTIR-ATR spectra of polypropylene samples with different oxidation times.

FIG. 2 The relationship between the absorbance ratio of FTIR-ATR spectra of oxidized polypropylene samples and the oxidation treatment time.

FIG. 3 FTIR-ATR spectra of strongly oxidized ultra-high-molecular-weight polyethylene samples.

FIG. 4 The relationship between the oxidation time and (A) C1s narrow spectrum and (B) O1s narrow spectrum in XPS measurement of polypropylene samples.

FIG. 5 The relationship between the ratio of the number of O1s/C1s orbitals determined from the XPS-narrow spectra of polypropylene samples and the oxidation treatment time.

FIG. 6 Relationship between the type and percentage of carbon bonds determined from the XPS-narrow spectra of polypropylene samples and the oxidation treatment time.

FIG. 7 The relationship between the oxidation treatment time and the percentage of the number of C—O—H bonds present in the polypropylene sample.

FIG. 8 Relative ratio of the tensile shear strength of the polypropylene cloth samples to the time of atmospheric pressure plasma discharge treatment of the polypropylene cloth.

FIG. 9 The relationship between the ozone treatment time of polypropylene cloth and the relative tensile shear strength of the treated samples.

FIG. 10 Relation between oxidation treatment time and tensile shear strength of a sample of DHM-treated polypropylene board bonded to an aluminum board.

FIG. 11 (A) Weight-displacement curves for a polypropylene (PP) fiber/epoxy resin fiber composite in a three-point bending test. (B) Weight-displacement curves of ultra-high molecular weight polyethylene (UHMWPE) fiber/epoxy resin fiber composites in a three-point bending test.

### MODE FOR CARRYING OUT THE INVENTION

The present disclosure is described below, showing the best possible form. It should be understood that singular expressions also include the concept of their plural forms throughout this specification, unless otherwise noted. Thus, it should be understood that articles in the singular (e.g., “a,” “an,” “the,” etc. in English) also include concepts in their plural forms, unless otherwise noted. It should also be understood that terms used herein are to be used in the sense normally used in the field, unless otherwise noted. Therefore, all technical and scientific terms used herein have the same meaning as generally understood by those skilled in the art to which this disclosure pertains, unless otherwise defined. In the event of any inconsistency, this specification (including definitions) prevails.

The present disclosure is explained below by using working examples with reference to the accompanying drawings, where necessary. It should be understood that expressions in the singular also include concepts in their plural forms throughout this specification, unless otherwise noted. It should also be understood that terms used herein are to be used in the sense normally used in the field, unless otherwise noted. Therefore, all technical and scientific terms used herein have the same meaning as generally understood by those skilled in the art to which this disclosure pertains unless otherwise defined. In the event of any inconsistency, this specification (including definitions) prevails.

The followings are definitions and/or basic technical details of terms specifically used herein as appropriate.

### Definitions, Etc.

In this description, “composite material” indicates a material in which plural different materials (which may be the same material) are molded as a single unit. For example, composite materials are molded products in which materials are interfacially adhered or bonded together, or molded products in which at least a portion of the materials are dissolved or melted, and the dissolved or melted portions are mixed and solidified. In particular, composite materials in which at least one of the materials are fiber can be “fiber composite materials”. In addition, “adhesive materials” herein show composite materials made by the adhesion between materials.

In this description, “X-ray photoelectron spectroscopy” (which may be abbreviated as XPS) refers to an analysis method that uses photoelectrons emitted when the surface of a sample to be measured is irradiated with X-rays, and is a widely used method for analyzing the surface layer of a sample to be measured. According to XPS, qualitative and quantitative analysis can be performed using the X-ray photoelectron spectra obtained by analysis on the surface of the sample to be measured. The relationship between the depth from the sample surface to the analysis position (hereinafter also referred to as “detection depth”) and the photoelectron extraction angle (hereinafter also referred to as “photoelectron extraction angle”) is called “detection depth. and the photoelectron extraction angle are generally related by the following equation,

Detection depth≈mean free path of electrons×3×sin θ

(where the detection depth is the depth at which 95% of the photoelectrons comprising the X-ray photoelectron spectrum are generated and θ is the photoelectron extraction angle).

From the above equation, it is understood that the smaller the photoelectron extraction angle, the shallower the depth from the sample surface can be analyzed, and the larger the photoelectron extraction angle, the deeper the depth. For example, in an XPS analysis at a photoelectron extraction angle of 10 degrees, the analysis position is usually at the very surface of the sample, at a depth of about several nm from the sample surface. In the X-ray photoelectron spectra (abscissa: binding energy (eV), ordinate: intensity) obtained by the analysis performed by XPS, for example, the C1s spectrum contains information about the energy peak of the is orbital of the carbon atom C.

The elemental composition of the material within the measurement range can be determined, for example, by wide scan measurement (scan range: 0 to 1000 eV, energy resolution: 1 eV/step, etc.), and the percentage of each element can be calculated from the peak area of the is spectrum corresponding to each element, for example. The bonding state for a particular element can be analyzed by narrow scan measurement (scan range: is spectral range for that element, energy resolution: 0.1 eV, etc.). For example, in the Cis spectrum, the C—H and C—C peaks are located at about 284.6 eV, the C—N peak is located at about 285.7 eV, the C—O peak is located at about 286.1 eV, the C═O peak is located at about 288 eV, and the O—C—O peak is located at about 289 eV. The positions of the other eV peaks for each bond of carbon or other elements are known or can be easily determined by those skilled in the field. The XPS analysis can be examined a surface of 0.1 mm² area of materials for example.

The term “resin” as used herein indicates a polymer of the same polymerizable compound or two or more polymerizable compounds with different structures, including single polymers (homopolymers) and copolymers (copolymers).

In this description, the term “about” refers to the indicated value plus or minus 10%, unless otherwise defined. The term “about” as used for ratios refers to the ratio of the left value (X) plus or minus 10% of the indicated ratio (described as X:Y, etc.). When “about” is used for temperature, it refers to the indicated temperature plus or minus 5° C.

(Preferable Embodiment)

In one aspect, the present disclosure provides a method of surface modification of materials, comprising (1) the step of oxidizing the material such that the oxidation level on the surface of the material (e.g., within 10 nm) is in a specific numerical range when measured by X-ray photoelectron spectroscopy (XPS) and (2) the step of surface coating.

In a preferred embodiment, the step of oxidation treatment can be performed to achieve a surface oxidation level of the material below a level detectable in the infrared absorption spectroscopy (IR). The present disclosure also provides a method of producing adhesive materials, including the step of interfacial adhesion or bonding the surface modified material to the second material. In this description, “interfacially adhering” means directly bonding between the materials. In this description, “to adhere” means to bond between the materials via adhesives.

In one aspect, the present disclosure provides a method of producing fiber composite materials in which the fiber material is contained within the second material, the method comprising the steps of (1) oxidizing at least one of the fiber material and the second material, (2) interfacially adhering or bonding the fiber material and the second material after the oxidizing step, and (3) melting the second material to obtain the fiber composite material. In a preferred embodiment, the second material is a resin material (including rubber).

In one aspect, the present disclosure provides composite materials (e.g., fiber composites) with a level of high strength previously unachievable.

(Material)

Materials to be interfacially adhered or bonded in the present disclosure are not particularly limited, but include polymer materials, metals, glass, ceramics, silicon resin, carbon materials, wood, and materials of composite materials thereof, and it is contemplated that interfacial adhesion or bonding between any of these materials is possible.

In one embodiment, as polymer materials (e.g., resins (including rubbers)), (1) additional polymers: monomers selected from the group consisting of olefins, vinyl compounds, vinylidene compounds, and other compounds having carbon-carbon double bonds, either as single-component polymers or copolymers, (2) fluorocarbon polymers: polytetrafluoroethylene, perfluoro alkoxy alkane, perfluoro ethylene propylene copolymer, perfluoro ethylene propene copolymer, ethylene-tetrafluoroethylene copolymer, polyvinylidene fluoride, polychlorotrifluoro ethine, ethylene-chlorotrifluoroethylene copolymer, tetrafluoroethylene perfluorodioxol copolymer, polyvinyl fluoride, (3) polycondensates: polyester (including polyethylene terephthalate and aliphatic and fully aromatic polyesters), polycarbonate, polybenzoate, polyimides, polyamides (including aliphatic and aromatic polyamides such as nylon), (4) addition-condensation compounds: phenolic resins, urea resins, melamine resins, xylene resins, or their polymers, (5) Polyaddition products: polyurethane, polyurea, etc., or their polymers, (6) ring-opening polymer: monopolymer or copolymer of cyclopropane, ethylene oxide, propylene oxide, lactone, lactam, etc., (7) cyclopolymer: monopolymer of divinyl compound (e.g. 1,4-pentadiene), diyne compound (e.g. 1,6-(8) isomerization polymer: e.g., alternating copolymer of ethylene and isobutene, (9) electropolymer: single polymer or copolymer of pyrrole, aniline, acetylene, etc., (10) silicon resin, silicon polymer resin, (11) polymers of aldehydes or ketones, (12) polyethersulfone, (13) natural polymers: cellulose, proteins, polysaccharides, etc. Other polymer materials (e.g., resins) include polyacetal, polyphenol, polyphenylene ether, polyalkyl paraoxy benzoates, polyimides, polybenzimidazole, poly-p-phenylenebenzobisothiazole poly-p-phenylenebenzobisoxazole, polybenzothiazole, polybenzoxazole, acetate for fiber, recycled cellulose fiber (rayon, cupra, polynosic, etc.), vinylon, vinyl alcohol/vinyl chloride copolymer fiber, etc. Polybenzoxazole, acetate, recycled cellulose fiber (rayon, cupra, polynosic, etc.), vinylon, vinyl alcohol and polyvinyl chloride copolymer fiber, etc.

Vinyl compounds, vinylidene compounds, and other compounds with carbon-carbon double bonds as monomers to form polymer materials (e.g., resins (including rubbers)) include ethylene, propylene, butene-1, pentene-1, hexene-1, 4-methyl-pentene-1, octene-1, vinyl chloride, styrene, acrylic acid, methacrylic acid, acrylic acid, and acrylate. -1, hexene-1, 4-methyl-pentene-1, octene-1, vinyl chloride, styrene, acrylic acid, methacrylic acid, esters of acrylic acid or methacrylic acid, vinyl acetate, vinyl ethers, vinylcarbazole, acrylonitrile, vinylidene chloride, vinylidene fluoride, isobutylene, maleic anhydride, pyromellitic anhydride, butenoic acid, butene tetrafluoroethylene, ethylene trifluoride chloride, butadiene, isoprene and chloroprene. Examples of specific polymer materials (e.g., resins) include polyester, polypropylene, polyethylene, polyolefin, acrylic, polyvinyl acetate, AS (acrylonitrile-styrene copolymer), ABS (acrylonitrile butadiene-styrene copolymer), polycarbonate, polyethylene terephthalate, polybutylene terephthalate, polymethyl methacrylate, polyaryldiglycol carbonate, copolymers containing butadiene, synthetic rubber, polyetheretherketone (PEEK), rayon, cupra, polystyrene (PS), polyphenylene sulfide (PPS), polyaramid, polyimide, polyamide (nylon), polymethylpentene (Mitsui Coorporation, Japan, TPX (registered trademark)), vinylon, cotton, linen, silk, wool, and others.

In one embodiment, the material may have a shape such as fiber, textile, nonwoven fabric, cloth, plate, film, sheet, tube, rod, hollow container, box, foam, laminate, etc. In one embodiment, the polymer material (e.g., resin) may be thermoplastic or thermoset.

In one embodiment, the material can be in the form of fiber, textile, non-woven fabric, cloth, plate, film, sheet, tube, rod, hollow container, box, foam, laminate, etc., but is not limited to any of these.

In one embodiment, the material (e.g., polymeric material) may contain additives such as antioxidants, stabilizers, nucleating agents, flame retardants, fillers, foaming agents, antistatic agents, etc.

(Treatment)

In one embodiment, prior to the surface modification treatment, the surface of the material may be washed to remove impurities. In one embodiment, the material may be washed with a solvent or mixture of solvents having an SP value that differs from the solubility parameter of the material by only about 0.5 to 10, e.g., about 0.5, 1, 1.5, 2, 3, 4, 5, 6, 7, 8, 9, 10 or any two of these values. For example, polyolefins, silicone resins, fluoropolymers, polyvinyl chloride, polyvinylidene chloride, etc. are preferably cleaned with alcohol or toluene. Acetate, nylon, polyester, polystyrene, acrylic resin, polyvinyl acetate, polycarbonate, and polyurethane are preferably cleaned with alcohol. Cellulosic materials such as rayon and cupro are preferably cleaned with detergent followed by alcohol. In one embodiment, silicone oil is preferred to be removed since it can inhibit oxidation of the material surface in the oxidation step described herein. To remove the silicone oil, the surface of the material may be cleaned with a solvent with a solubility parameter=about 7 to 10 (e.g., about 7, 8, 9, 10, or a range between any two of these values), such as isopropyl alcohol, nax-Silicon Off SP (Nippon Paint Corporation.). In one embodiment, the material may be cleaned with a cleaning agent in a volume of about 0.05 to 1 times the volume of the material, such as about 0.05, about 0.1, about 0.2, about 0.3, about 0.4, about 0.5, about 0.7, about 1 times, or a range between any two of these values. In one embodiment, the material can be washed with the detergent two to five times. In one embodiment, the cleaning can be performed with a combination of solvents and temperatures that do not dissolve the surface of the material.

In one embodiment, prior to the surface modification treatment, the material surface may be roughened by scratching (e.g., sanding), which may increase the area of interfacial adhesion or bonding and improve the strength of the formed composite material. In one embodiment, the material (especially the polymeric material) may be impregnated prior to the surface modification treatment. The impregnation treatment is a process whereby a compound that has an affinity for the material (impregnating agent) is brought into contact with the material at a temperature below the softening point of the material to introduce the impregnating agent to the surface of the material. The impregnation process should not substantially deform the material. The impregnating agent can seep into the non-crystalline areas of the material, forming gaps inside the material. The impregnation treatment can facilitate the oxidizing step, grafting step, etc. in the surface modification process. Any compound that has an affinity for the material can be used as an impregnating agent. In one embodiment, the impregnating agent can be a solvent or solvent mixture having an SP value that differs from the solubility parameter (SP value) of the material by about 0.5, 1, 2, 3, 4, or 5. Even solvents that dissolve materials at room temperature can be used as impregnating agents if used at low temperatures and/or for short periods of time. The impregnating agent can be selected corresponding to the type of material. For example, for polypropylene materials, toluene, xylene, decalin, tetralin, cyclohexane, a mixture of 1 volume of dichloroethane and 4 volumes of ethanol can be used as impregnating agents, and for polyethylene materials, toluene, xylene, For polyethylene materials, mixtures of toluene, xylene, α-chloronaphthalene, dichlorobenzene 1 volume and methanol 1 volume can be used as impregnating agents; for polystyrene materials, mixtures of toluene 1 volume and methanol 10 volume can be used as impregnating agents; and for polyethylene terephthalate materials, mixtures of phenol 1 volume and hexane 10 volume can be used as impregnating agents. For polyethylene terephthalate materials, a mixture of 1 volume of phenol and 10 volumes of hexane can be used as an impregnating agent.

In one embodiment, the surface modification of the present disclosure includes the step of oxidation treatment of the material surface. In one embodiment, the oxidation treatment of the material is performed such that the (major elemental bonds to oxygen (e.g., C—O bonds, Si—O bonds, etc.))/(total same elemental (e.g., carbon, silicon) bonds) % within 10 nm depth of the surface of this material increases about 1-20%, 1.5-15%, or 2-10% from before the oxidation treatment, when measured by XPS. In one embodiment, the oxidation treatment of the material can be performed such that the (major elemental bonds to oxygen (e.g., C—O bonds, Si—O bonds, etc.))/(all-elemental (e.g., carbon, silicon) bonds) % within 10 nm depth of the surface of this material becomes about 3-25%, about 4-20% or about 5-15%, when measured by XPS.

In one embodiment, the oxidation treatment of the material can be performed such that the percentage of oxygen atoms in all atoms except hydrogen within a depth of 10 nm of the surface of this material increases by about 1-20%, about 1.5-15% or about 2-10% over the pre-oxidation treatment, when measured by XPS. In one embodiment, the oxidation treatment of the material can be performed such that the percentage of oxygen atoms in all atoms except hydrogen within a depth of 10 nm of the surface of this material is about 3-25%, 4-20% or 5-15%, when measured by XPS.

In one embodiment, the oxidation treatment of the material can be performed under conditions such that the (C—O bonds)/(total carbon bonds) % within a depth of 10 nm of the material surface of the block polypropylene material increases by about 1-20%, about 1.5-15%, or about 2-10% from before the oxidation treatment, when measured by XPS. In one embodiment, the oxidation treatment of the material can be performed under conditions such that the (C—O bonds)/(total carbon bonds) % within a depth of 10 nm of the surface of the material of the block polypropylene material is about 3-25%, about 4-20% or about 5-15%, when measured by XPS.

In one embodiment, the oxidation treatment of the material is performed under conditions such that the percentage of oxygen atoms in all atoms except hydrogen within a depth of 10 nm of the surface of the material of the block polypropylene material increases by about 1 to 20%, about 1.5 to 15% or about 2 to 10% from before the oxidation treatment, when measured by XPS. In one embodiment, the oxidation treatment of the material can be performed under conditions such that the percentage of oxygen atoms in all atoms except hydrogen within a depth of 10 nm of the surface of the block polypropylene material is about 3-25%, 4-20% or 5-15%, when measured by XPS.

In one embodiment, the oxidation treatment of a material can be performed under conditions such that the oxygen atom/carbon atom ratio within a depth of 10 nm of the material surface of the block polypropylene material increases by about 1-20%, about 1.5-15% or about 2-10% from before the oxidation treatment, when measured by XPS. In one embodiment, the oxidation treatment of a material can be performed under conditions such that the oxygen atom/carbon atom ratio within a depth of 10 nm of the material surface of the block polypropylene material is about 3-25%, 4-20% or 5-15%, when measured by XPS.

The source in the above XPS measurement can be, for example, a Cr Kα ray, Al Kα ray, etc. The incident angle in the above XPS measurement can be, for example, about 10°, about 20°, about 30°, about 40°, about 50°, about 60°, about 70°, about 80° or about 90°. The extraction angle in the above XPS measurement can be, for example, about 10°, about 20°, about 30°, about 40°, about 50°, about 60°, about 70°, about 80° or about 90°. The number of atoms or bonds in the above XPS measurement can be derived from is measurements only. The above XPS measurement can be performed after the oxidation treatment and the washing of the material.

The degree of introduction of oxygen by the oxidation treatment can also be measured by infrared absorption spectra, for example, the ratio of the absorbance of absorption based on the carbonyl group introduced in the oxidized material to the absorbance of absorption based on the unchanged crystal portion structure. For example, in the case of polypropylene material, the ratio of the absorbance around 1710 cm⁻¹ based on the carbonyl group to the absorbance at 973 cm⁻¹ of the absorption based on the unchanged crystal portion methyl group can be used as an indicator of the introduction of oxygen. However, the inventors found that oxidation treatment to a degree that is detectable in the infrared absorption spectrum is generally excessive and can rather reduce the strength of the adhesive or composite material, and that a degree of oxidation treatment that results in the above specified numerical range is preferred, when measured by X-ray photoelectron spectroscopy (XPS). The degree of oxidation treatment is preferable to achieve the above specific range of values when measured by XPS. In particular, excessive oxidation treatment in adhesive or composite materials using fiber- or film-shaped materials can lead to a reduction in strength. The degree of oxidation treatment can be easily set by a person skilled in the art by adjusting the time of treatment, etc.

In one embodiment, the method described herein includes the step of oxidizing the surface of a fiber material (which can include film-shaped materials as well as fiber-shaped materials). The fiber material can be any material, e.g., a polymer material (e.g., resin), metal, glass, carbon material, or a composite material of any of the materials described herein. In one embodiment, the fiber material can be polyester, polypropylene, polyethylene, nylon, acrylic, polyvinyl acetate, rayon, cupro, vinylon, polystyrene (PS), polyphenylene sulfide (PPS), polyaramide, polyimide or polyamide. In one embodiment, the fiber material can be a mixed fiber material which is a mixture of multiple fiber materials. In particular, both high strength and high toughness can be achieved by using a mixture of high strength fibers (such as carbon fibers, glass fibers, etc.) and high toughness fibers (such as polypropylene fibers) to create a fiber resin composite material. In one embodiment, the fiber material may have the following diameter, e.g. about 10 nm to about 1000 μm, about 100 nm to about 1000 μm, about 1 μm to about 1000 μm, about 10 m to about 1000 μm, about 100 μm to about 1000 μm, about 10 nm to about 100 μm, about 100 nm to about 100 μm, about 1 μm to about 100 μm, about 10 μm to about 100 μm, about 10 nm to about 10 μm, about 10 nm to about 10 μm, about 1 μm to about 10 μm, about 10 nm to about 1 μm, about 100 nm to about 1 μm or about 10 nm to about 100 nm, but may not limited to. The smaller the diameter, the lower the degree of oxidation treatment can be preferred. In one embodiment, the fiber material may be made of thin diameter (e.g., about 1 μm to about 100 μm) filaments twisted together to form thicker diameter (e.g., about 100 μm to about 1000 μm) fibers.

The step of oxidation treatment can be performed by plasma treatment, ozone treatment, ultraviolet irradiation treatment, high-pressure discharge treatment, chemical oxidation, etc.

The ozonation is a treatment in which the material surface is exposed to ozone. The exposure method can be any method, such as holding the material in an atmosphere where ozone is present for a predetermined time, or exposing the material in an ozone gas stream for a predetermined time. Ozone can be generated by supplying oxygen-containing gas, such as air, oxygen gas, or oxygenated air, to an ozone generator, and the ozone-containing gas can be introduced into a container or the like in which the material is held for the ozone treatment. The ozone concentration in the ozone-containing gas, exposure time, exposure temperature, and other conditions can be determined according to the material to achieve the degree of oxidation of the material described herein.

The plasma treatment is a process in which the material is placed in a container containing argon, neon, helium, nitrogen, nitrogen dioxide, oxygen, or air, and exposed to plasma generated by glow discharge. When inert gases such as argon or neon are present at low pressure, the material surface is attacked by the generated plasma and radicals can be generated on the surface. Subsequent exposure to air can cause the radicals to combine with oxygen and introduce carboxylic acid groups, carbonyl groups, amino groups, etc. to the material surface. To achieve the degree of oxidation of the material described herein, conditions such as intensity of glow discharge, time, and type of gas can be determined according to the material.

Ultraviolet irradiation treatment is a process in which the surface of the material is irradiated with ultraviolet light. Low-pressure mercury lamps, high-pressure mercury lamps, ultra-high-pressure mercury lamps, xenon lamps, metal halide lamps, etc. can be used as light sources for UV irradiation. In one embodiment, the surface of the material may be treated with a UV absorbing solvent prior to irradiation. Conditions such as wavelength, intensity, and irradiation time of the UV light can be determined according to the material to achieve the degree of oxidation of the material described herein. In one embodiment, the wavelength of the UV light can be 360 nm or less.

The high-voltage discharge treatment is a process in which a high voltage of several hundred thousand volts is applied between a number of electrodes installed on the inner wall of the treatment device and discharged in air while the material is moved in a tunnel-shaped treatment device. The intensity, duration, and other conditions of the discharge can be determined according to the material to achieve the degree of oxidation of the material described herein.

The corona discharge treatment is a process in which a high voltage of several thousand volts is applied between a grounded metal roll and wire-like electrodes placed at intervals of several millimeters thereto to generate a corona discharge, and the material is passed between the electrodes and roll during this discharge. The intensity, time, and other conditions of the discharge can be determined according to the material so that the degree of oxidation of the material is according herein.

The chemical oxidation is an oxidation treatment in which a compound with an oxidation ability (oxidant) is applied to the material surface. The oxidizing agent can be selected by a person skilled in the art from any suitable one in the art.

In one embodiment, the treatment for oxidizing the material surface other than ozone treatment is preferred when there is a shadowed area due to the shape of the material, such as a fiber aggregate like nonwoven fabric, because the surface is oxidized by radiation to the material.

In one embodiment, the steps of surface coating are (a) grafting a hydrophilic vinyl monomer onto the oxidized material, (b) grafting a hydrophilic monomer and coating a hydrophilic polymer, (c) coating a hydrophilic polymer, (d) coating a hydrophilic polymer and grafting a hydrophilic monomer, or (e) grafting a vinyl ester monomer and subjecting it to a hydrolysis. Whether the monomers and polymers are hydrophilic is usually understood by those skilled in the art based on the presence of hydroxyl, carboxyl, phosphate, or sulfo groups, or their solubility in water. Specific examples of these monomers and polymers are described elsewhere herein.

In one embodiment, the step of surface coating does not substantially increase the weight of the oxidized material. The usual grafting process may increase the sample weight by 10-20%, in which case the grafted portions may desorb. On the other hand, the surface coating of the present disclosure may be preferred because it is less likely to cause such problems. In one embodiment, the step of surface coating increases the weight of the oxidized material by less than about 5%, less than about 2%, less than about 1%, less than about 0.5%, less than about 0.2%, or less than about 0.1%.

In one embodiment, the surface modification of the present disclosure may include the step of grafting a monomer onto the surface of a material. The step of grafting may be performed after the step of oxidizing the surface or after the step of treating (applying) the material with a polymer. The monomers to be grafted are not restricted as long as they are graftable, but compounds with carbon-carbon double bonds can be used. As hydrophilic monomers, for example, (meth)acrylamide, hydroxyalkyl (meth)acrylates such as 1-hydroxyethyl (meth)acrylate, hydroxypropyl (meth)acrylate, hydroxybutyl (meth)acrylate, 1 (alkyl)aminoalkyl (meth)acrylates such as 1-dimethylaminoethyl (meth)acrylate and 1-butylaminoethyl (meth)acrylate, alkylaminoalkyl (meth)acrylates such as ethylene glycol mono (meth)acrylate and propylene glycol mono (meth)acrylate, etc. Alkylene glycol mono(meth)acrylates such as ethylene glycol mono(meth)acrylate, propylene glycol mono(meth)acrylate, polyethylene glycol mono(meth)acrylate, polypropylene glycol mono(meth)acrylate, ethylene glycol allyl ethers, ethylene glycol vinyl ether, (meth)acrylic acid, aminostyrene, hydroxystyrene, vinyl acetate, glycidyl (meth)acrylate, allyl glycidyl ether, vinyl propionate, N,N-dimethyl methacrylamide, N,N-diethyl methacrylamide, N-(1-hydroxyethyl) methacrylamide, N-isopropyl methacrylamide, methacryloyl morpholine, N-vinyl-1-pyrrolidone, N-vinyl-3-methyl-1-pyrrolidone, N-vinyl N-vinyl-4-methyl-1-pyrrolidone, N-vinyl-5-methyl-1 N-vinyl-4-methyl-1-pyrrolidone, N-vinyl-5-methyl-1-pyrrolidone, N-vinyl-6-methyl-1-pyrrolidone, N-vinyl-3-ethyl-1-pyrrolidone, N-vinyl-4,5-dimethyl-1-pyrrolidone, N-vinyl-5,5-dimethyl-1-pyrrolidone, N-vinyl-3,3,5-trimethyl-1-pyrrolidone, N-vinyl-1-piperidone, N-vinyl-3-methyl-1-piperidone, N-vinyl-4-methyl-1-piperidone, N-vinyl-5-methyl-1-piperidone, N-vinyl-6-methyl-1-piperidone, N-vinyl-6-ethyl-1-piperidone, N N-vinyl-6-methyl-1-piperidone, N-vinyl-6-ethyl-1-piperidone, N-vinyl-3,5-dimethyl-1-piperidone, N-vinyl-4,4-dimethyl-1-piperidone, N-vinyl-1-caprolactam, N-vinyl-3 N-vinyl-3-methyl-1-caprolactam, N-vinyl-4-methyl-1-caprolactam, N-vinyl-7-methyl-1-caprolactam, N-vinyl-7-ethyl-1-caprolactam, N-vinyl-7-ethyl-1-caprolactam, N-vinyl-3,5-dimethyl-1-caprolactam, N-vinyl-4,6-dimethyl-1-caprolactam, N-vinyl-3,5,7-trimethyl-1-caprolactam, N-vinyl lactams such as N-vinyl-4,6-dimethyl-1-caprolactam, N-vinyl-3,5,7-trimethyl-1-caprolactam, N-vinylformamide, N-vinyl-N-methylformamide, N-vinyl-N-ethylformamide, N-vinylacetamide, N,N-vinyl acetamide, N-vinyl-N-ethylacetamide, N-vinylphthalimide, N-vinylacetamide, N-vinylamide, vinylacetic acid, 1-butenic acid, 2-butenic acid, ethylene sulfonic acid, hydroxyalkyl acrylate, hydroxyalkyl methacrylate, acrylamide, vinyl pyridine, vinylpyrrolidone, vinylcarbazole, maleic anhydride, and pyromellitic anhydride. Less hydrophilic monomers include vinyl monomers such as acrylates, methacrylates, vinyl acetates, styrene, etc. One monomer or a mixture of several monomers can be used for grafting.

The monomer grafting can be carried out by (1) the addition of a catalyst or initiator (hereinafter collectively referred to as “initiator”), (2) the heating in the presence or absence of an initiator, (3) the UV irradiation in the presence or absence of a catalyst or initiator. As initiators, peroxides (benzoyl peroxide, t-butyl hydroxyperoxide, di-t-butyl hydroxyperoxide, etc.), azo compounds (2,2′-azobisisobutyronitrile), dicerium ammonium nitrate (IV), persulfates (potassium persulfate, ammonium persulfate, etc.), redox initiators (oxidants: persulfates, hydrogen peroxide, hydroperoxides, etc. and inorganic reducing agents: copper salts, iron salts, sodium hydrogen sulfite, sodium thiosulfate, etc. or with organic reducing agents: alcohols, amines, oxalic acid, etc., or with oxidants: hydroperoxides, etc., inorganic reducing agents: copper salts, iron salts, sodium hydrogen sulfite, sodium thiosulfate, etc., or with organic reducing agents: dialkyl peroxide, diacyl peroxide, etc., reducing agent: tertiary amine, naphthenates, mercaptans, organometallic compounds (triethylaluminum, triethylboron, etc.), and other known radical polymerization initiators. In the case of UV irradiation, in addition to the initiator, photosensitizers such as benzophenone and hydrogen peroxide may be added as catalysts. In one embodiment, a vinyl monomer having an amide group may be used and The Hoffman rearrangement of amide groups can be performed by the method described in Japanese Laid-Open Patent Publication No. H8-109228(1996).

General grafting methods can be used for grafting monomers. Specific examples are shown below. For water-soluble initiators, the required amount of initiator is dissolved in water. For water-insoluble initiators, the initiator is dissolved in an organic solvent (acetone, methanol, etc.) that can be mixed in water, such as alcohol or acetone, and then mixed with water to prevent the initiator from precipitating out. The material and monomer are added to the initiator solution for grafting. In one embodiment, the inside of the processing vessel is replaced with nitrogen. In one embodiment, the grafting is performed under the heating and/or UV irradiation.

In one embodiment, the surface modification of the present disclosure includes the step of treating (e.g., coating) the surface of the material with a polymer. Examples of polymers used in this step include polyvinyl alcohol, carboxymethyl cellulose, ethylene/vinyl alcohol copolymers, polyhydroxyethyl methacrylate, poly-α-hydroxyvinyl alcohol, polyacrylic acid, poly-α-hydroxy acrylic acid, polyvinyl pyrrolidone, polyalkylene glycols (polyethylene glycol, polypropylene glycol, etc.) and their sulfonates, sodium alginate, starch, silk fibroin, silk sericin, gelatin, various proteins, polysaccharides, etc.

In one embodiment, the step of treating the material surface with a polymer can be performed in the presence of a catalyst or initiator. The catalyst and initiator can be similar to the initiator in monomer grafting. In one embodiment, this step is carried out by adding a solution (e.g., an aqueous solution) containing the polymer to the material. For example, the material is placed in a solution containing the polymer and initiator and heated to a temperature of 10-80° C., 60-90° C., etc.

In one embodiment, the surface modification of the present disclosure includes the step of washing excess polymer attached to the surface. For example, the material treated with a hydrophilic polymer may be subjected to a boiling wash in a sodium fatty acid solution (1-10% by weight concentration) for 1-10 minutes, followed by well-washing. In one embodiment, the surface of the material treated with the hydrophilic polymer after washing may be washed to the extent that no difference is seen between its infrared absorption spectrum and the infrared absorption spectrum of the material treated only with oxidation treatment when the total reflectance infrared absorption spectrum is measured. If the material is treated with a less hydrophilic monomer or polymer, e.g., methyl methacrylate or polymer thereof, or vinyl acetate or polymer thereof, it can be washed with chloroform at 40° C. for 10-60 minutes and further washed with chloroform or acetone or methanol. In one embodiment, the material is washed until the absorption near 1710 cm⁻¹ due to the carbonyl groups of the treated material in the total reflection infrared absorption spectrum measurement shows an increase in absorbance of about 0-5% compared to the oxidation treated material only. In one embodiment, the material can be effectively cleaned by heating and then cleaning in an ultrasonic cleaner. In one embodiment, the degree of cleaning and the cleaning agent used can be set appropriately by the person skilled in the art using the strength of the adhesive or composite material as an indicator.

In one embodiment, the material surface modified by the method of the present disclosure can be interfacially close-contact or adhesion to the second material to form an adhesive material. In one embodiment, the material surface modified by the method of the present disclosure can be the same material as the second material or a different material. In one embodiment, the second material may be surface modified (e.g., surface modified by the methods of the present disclosure).

In one embodiment, an adhesive may or may not be used in the step of interfacial adhesion or bonding with the second material. Any known adhesive such as starch, polyvinyl acetate, polyvinyl pyrrolidone, polyvinyl alcohol, epoxy resin-based, polymerizable cyanoacrylate, etc. may be used as an adhesive. In one embodiment, the step of interfacial adhesion or bonding with the second material may be performed by applying a small amount of solvent that can dissolve both the surface modified material and the second material by the methods of this disclosure and adhering the applied portions. Although interfacial adhesion or bonding to polytetrafluoroethylene or polyimide can be relatively difficult, strong bonded or composite materials fabricated from these materials can also be achieved in accordance with the methods of the present disclosure. The surface-modified material by the method of the present disclosure does not need to be interfacially adhesion or bonding to the second material immediately. The surface-modified material can bond tightly to the second material after a period of time (e.g., about 30 minutes, about 1 hour, about 2 hours, about 5 hours, about 10 hours, about 15 hours, about 20 hours, about 1 day, about 2 days, about 5 days, about 10 days, about 15 days, about 20 days, about 25 days, about 30 days, etc.). The material can be firmly bonded to the second material even after about 15 hours, about 20 hours, about 1 day, about 2 days, about 5 days, about 10 days, about 15 days, about 20 days, about 25 days, about 30 days, etc.). Therefore, the surface-modified material itself by the method of the present disclosure is also an object of the present disclosure.

In one embodiment, the present disclosure provides a method of producing a fiber composite material in which the fiber material is contained within the second material. In one embodiment, the fiber material in this method can have the characteristics of the fiber material in the step of oxidizing the surface of the fiber material described herein. In one embodiment, the method includes the steps of (1) oxidizing at least one of the fiber material and the second material, (2) interfacially adhesion or bonding the fiber material and the second material after the oxidizing step, and (3) melting the second material to obtain the fiber composite material. In one embodiment, the second material can be a semi-solid material such as rubber, in which case melting of the second material refers to, for example, increasing fluidity by subjecting it to a high temperature and does not necessarily involve a phase change from solid to liquid. In this embodiment, typically the second material is a thermoplastic resin, such as polyester, polypropylene, polyethylene, polyolefin, acrylic, polyvinyl acetate, AS (acrylonitrile-styrene copolymer), ABS (acrylonitrile-butadiene-styrene copolymer), polycarbonate, polyethylene terephthalate, polybutylene terephthalate, polymethyl methacrylate, polyaryl diglycol carbonate, copolymers containing butadiene, synthetic rubber, polyether ether ketone (PEEK), rayon, cupra, polystyrene (PS), polyphenylene sulfide (PPS), polyaramid, polyimide, polyamide (nylon), polymethyl pentene (TPX (registered trademark of Mitsui Chemical Corporation.)), vinylon, silicone, and other resins. In one embodiment, the second material can be a soft material such as rubber. In one embodiment, to strengthen the bond in step (2), the second material can be in a shape that increases the contact area with the fiber material, such as powder, granules, film, etc. In one embodiment, in step (2), the material may be subjected to pressure (e.g., pressing) and/or heating. In one embodiment, both the fiber material and the second material are oxidized. In one embodiment, melting of the second material can be performed at any suitable temperature, and it is performed below the temperature at which the second material denatures or decomposes. In one embodiment, the method includes the steps of (1) oxidizing the fiber material, (2) mixing the fiber material and the second material (fluid) before curing after the oxidizing step, and (3) subjecting the mixture of step (2) to conditions in which the second material cures. In this embodiment, typically the second material is a thermosetting resin (e.g., epoxy resin). In this embodiment, the conditions for curing the second material can be appropriately determined by a person skilled in the art depending on the second material used.

(Composite Materials)

In one aspect, the present disclosure provides high-strength composite materials (e.g., fiber composites). The methods of the present disclosure can significantly improve the interfacial adhesion between materials, and thus can provide high-strength composite materials. In one aspect, the composite materials of the present disclosure (e.g., fiber composites) can be characterized by no-breaking at or beyond the breaking point (the point at which the load on the instrument decreases significantly when the load is increased in a bending or tensile test). The fibers and the second material can each have the material, shape and/or properties described in the methods for making fiber composite materials described herein. In one embodiment, the weight percentage of fiber material in the composite material of the present disclosure can be less than about 40%, less than about 30%, less than about 20%, less than about 10%, or less than about 5%. Even when a smaller percentage of fiber material is used than in conventional fiber composites, the composite material of the present disclosure can have sufficient strength, which can be desirable for manufacturing, and can also have the advantage of reducing the burden of disposal of carbon fiber, which can be problematic.

In one embodiment, the composite material of the present disclosure can have a high strength that has not been achieved previously. In one embodiment, the composite materials of the present disclosure are at least partially connected at or beyond the break point (e.g., at a displacement distance or displacement distance increased by 5% or 1% from the break point), when a specimen of said composite material 80 mm long, 10 mm wide, and 2 mm thick is subjected to a three-point bend test or tensile test at a speed of 2 mm/min and a support point distance of 40 mm. In one embodiment, the composite material of the present disclosure has a bending strength of approximately 1.1 times, 1.2 times, 1.5 times, 1.7 times, or 2 times greater than composite materials made under the same conditions except without the oxidation step, when a specimen of said composite material 80 mm long, 10 mm wide, and 2 mm thick is tested in a 3-point bend at a speed of 2 mm/min and a support point distance of 40 mm. In one embodiment, the composite material of the present disclosure provides an increase in bending strength of about 10 MPa or more, about 20 MPa or more, about 50 MPa or more, about 70 MPa or more, or about 100 MPa or more compared to composite materials made under the same conditions except for the absence of the oxidation step, when subjected to a 3-point bend test on a specimen of said composite material 80 mm long, 10 mm wide, and 2 mm thick, at a speed of 2 mm/min and a distance between support points of 40 m.

In one embodiment, the composite material of the present disclosure has a tensile shear strength of about 1.1 times or more, about 1.2 times or more, about 1.5 times or more, about 1.7 times or more, or about 2 times or more, compared to the composite materials prepared under the same conditions except without the oxidation step, when a specimen of said composite material 80 mm long, 10 mm wide, and 2 mm thick is tested in the tensile test at a tensile speed of 20 mm/min and a support point distance of 40 mm. In one embodiment, the composite material of the present disclosure provides an increase in tensile shear strength of about 50 kgf or more, about 70 kgf or more, about 100 kgf or more, or about 200 kgf or more, compared to composites prepared under the same conditions except without the oxidation step, when a specimen of said composite material 80 mm long, 10 mm wide and 2 mm thick is tested in the tension test at a tensile speed of 20 mm/min and a support point to point distance of 40 mm.

In one embodiment, a composite material of a fiber and the second material of the present disclosure can have a bending strength that is about 1.1 times or more, about 1.2 times or more, about 1.5 times or more, about 1.7 times or more, or about 2 times or more, compared to that of the second material alone, when evaluated by a three-point bending test on a specimen 80 mm long, 10 mm wide and 2 or 3 mm thick at a speed of 2 mm/min and a distance between support points of 40 mm. The resin composites of the present disclosure (e.g., fiber-resin composites) have a high interfacial adhesion or bonding between materials, so that the same or different types of resins can be further mixed (e.g., by mixing melted resins together) for the resin portion while maintaining the strength of the composite material. Therefore, the resin composite material of the present disclosure (e.g., fiber-resin composite) can be used not only as a final product, but also as a core material, and can be used to make a variety of molded products.

In one embodiment, the interface adhesion or bonded adhesive material of the first and the second materials can have the values of an oxygen atom/carbon atom ratio and/or (C—O bonds)/(total carbon bonds) % within a depth of 10 nm of the material surface which are obtained when the cut surface of at least one of the first material side half material and the second material side half material obtained by cutting the adhesive material along the interface between the first material and the second material measured by X-ray photoelectron spectroscopy (XPS), and in which the values can correspond to those attained on the material surface by the oxidizing step of the present disclosure. In one embodiment, the interface adhesion or bonded adhesive material of the first and the second materials shows an increase in the percentage of oxygen atoms in all atoms except hydrogen and/or (C—O bonds)/(total carbon bonds) % within a depth of 10 nm of the material surface, compared to the central region of the material, which are obtained when the cut surface of at least one of the first material side half material and the second material side half material obtained by cutting the adhesive material along the interface between the first material and the second material measured by X-ray photoelectron spectroscopy (XPS). The increase can be the increase in percentage achieved on the material surface by the oxidizing step of the present disclosure when compared to the same untreated material.

(Surface Modified Materials)

In one aspect, the present disclosure provides a surface modified material by the method of the present disclosure. In one embodiment, this surface modified material is used as an adhesive material to provide an adhesive or composite material. Since materials surface modified by the method of the present disclosure can provide high-strength adhesive or composite materials, even if they are not formed into adhesive or composite materials immediately after surface modification, they can also be useful prior to interfacial adhesion or bonding of materials. In one embodiment, this surface-modified material can be used for the applications other than providing an adhesive or composite material, for example, the methods of the present disclosure can enable the surface modification without compromising the strength of the material, so the surface modified material can be suitable for a coating (e.g., by hydrophilic materials coating). Surface modified materials so coated are also contemplated in the present disclosure.

In one embodiment, the surface modified material of the present disclosure is surface modified as follows. When a tensile strength test of a specimen of surface-modified material with 10 mm wide and 1 mm thick which is bonded to an aluminum plate of 0.2 mm thick with the bonding area of 10 mm×10 mm is carried out under the condition that a tensile speed of 20 mm/min and a distance of 60 mm between support points, the shear strength of the adhesive material is improved by about 150 N or more, 200 N or more, 250 N or more, 300 N or more, 350 N or more, 400 N or more, or 450 N or more, compared to the adhesive materials made from materials prepared under the same conditions except without the step of oxidation treatment.

(Uses) The adhesive materials, composite materials or surface-modified materials of the present disclosure can be used in any application. For example, they can be used in parts of transportation vehicles (automobiles, aircraft, etc.), parts of medical instruments, dental materials, building materials, surface coatings, laminated materials, etc. The adhesive materials, composite materials, or surface-modified materials of the present disclosure can also be suitably used in any of the applications in which the respective materials comprising the adhesive materials or composite materials are used. The methods of the present disclosure also provide adhesive materials, composite materials or surface-modified materials for these applications.

The present disclosure has been described above with preferred embodiments shown for ease of understanding. The disclosure is described below based on examples. The above description and the following examples are provided for illustrative purposes only, and are not provided for the purpose of limiting the disclosure. Accordingly, the scope of the invention is not limited to the embodiments specifically described herein nor to the examples, but is limited only by the claims.

### EXAMPLES

In the following examples, polymerization inhibitors contained in the monomer reagent were simply adsorbed and removed by passing the monomer reagent through a glass column packed with activated carbon. Basically, the grafting was performed under a nitrogen atmosphere.

### Example 1: Evaluation of Oxidation by FTIR and XPS Measurements

The oxidized materials were evaluated by FTIR and XPS measurements, respectively.

(Oxidation treatment) Polypropylene plates (10 mm×80 mm×0.5 mm) (AZ1 61-6034-78) were oxidized by plasma treatment in air. The apparatus was an atmospheric pressure plasma apparatus (Sakigake Semiconductor Corporation. (Kyoto) desktop direct type TK-50) connected to a sample feeder of our own manufacture, with an output scale of 60 V (maximum scale 130).

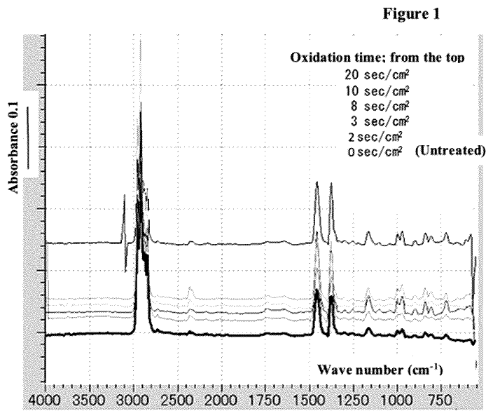

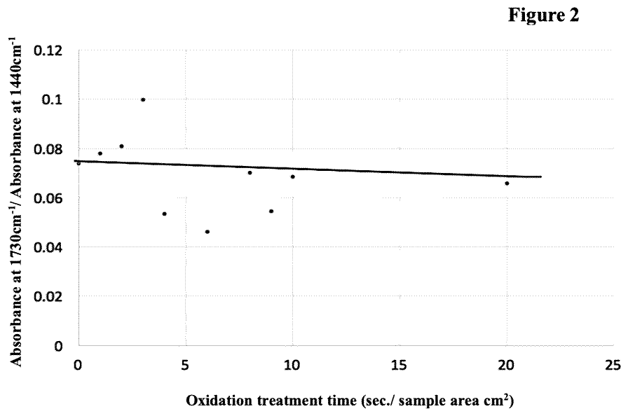

(Fourier transform infrared spectrometer (FTIR) analysis) Oxidized samples were washed with solvent (nax Silicon Off SP: Nippon Paint Corporation.) and water, dried, and then measured by Fourier transform infrared spectrophotometer IRPrestige-21 (Shimadzu Corporation, Kyoto, Japan)) using the total reflection method (ATR). The results are shown in FIGS. 1 and 2.

The ATR method of FTIR is said to be able to measure bonding states within a depth of about 10 m from the surface. FIG. 1 shows the spectra of six samples with different oxidation times. In general, when a sample is oxidized, carbonyl groups are formed, so the changes in absorbance around 1730 cm⁻¹, the absorption band of the carbonyl groups, are observed. In FIG. 1, there is no significant difference in absorbance around 1730 cm⁻¹.

In order to compare the absorbance relatively, the ratio, “absorbance at 1730 cm⁻¹/absorbance at 1440 cm⁻¹” was obtained, using the absorbance at the absorption peak 1440 cm⁻¹, which is almost unchanged during the strong oxidation process, as the denominator. The relationship between the absorbance ratio and oxidation time is plotted in FIG. 2. The absorbance ratios were dispersed with respect to the oxidation time and showed no correlation. From the comparison with the XPS results described below, it was determined that the trace amount of oxidation desirable for this surface treatment was difficult to measure with the sensitivity of FTIR-ATR.

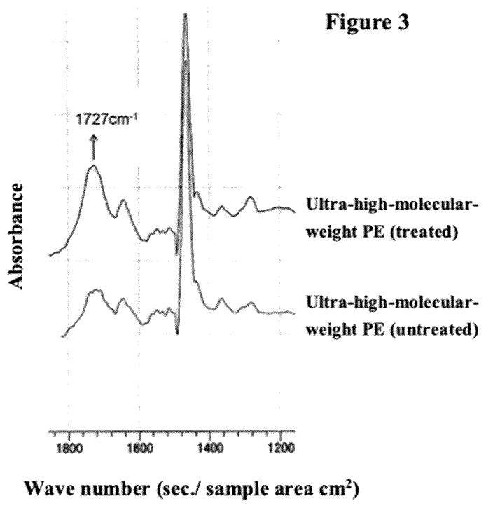

In the case of intense oxidation without regard to material breakdown, an increase in absorbance of 1727 cm⁻¹ was observed by IR measurement of ultra-high-molecular-weight polyethylene (UHMWPE) samples (FIG. 3).

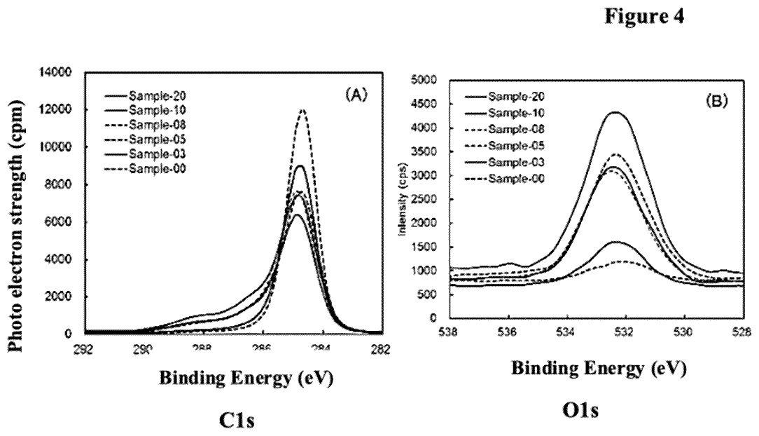

(Analysis by X-ray photoelectron spectroscopy (XPS)) Polypropylene samples measured by the ATR method of FTIR were analyzed by X-ray photoelectron spectroscopy (XPS). The results are shown in FIGS. 4, 5, 6, and 7. XPS measurements were made under conditions that allowed measurement of bonding states at depths within about 10 nm from the surface. The conditions for XPS analysis is as follows. Instrument: PHI-5000VersaProbeII (ULVAC Phi Corporation, Kanagawa, Japan), source: CrKα ray, AlKα ray, extraction angle: 90°.

FIG. 4 shows (A) C1s narrow spectra and (B) O1s narrow spectra in XPS measurements of polypropylene samples with different oxidation treatment times. The relationship between the C1s amount (%), O1s amount (%), and O/C atomic number ratio determined from the spectra is shown in Table 1.

TABLE 1
Relationship between the oxidation time of polypropylene and
C1s amount (%), O1s amount (%), and O/C atom number ratio.

| Treatment time | | | |
|---|---|---|---|
| (sec/cm²) | C1s | O1s | O/C |
| 0 | 97.6 | 2.4 | 0.025 |
| 2 | 93.2 | 6.8 | 0.073 |
| 3 | 93.4 | 6.7 | 0.072 |
| 4 | 90.2 | 9.8 | 0.109 |
| 5 | 84.2 | 15.8 | 0.188 |
| 6 | 84.9 | 15.1 | 0.178 |
| 7 | 84.3 | 15.7 | 0.186 |
| 10 | 82.5 | 17.5 | 0.212 |
| 20 | 81.1 | 18.9 | 0.233 |

Table 2 shows the type of carbon bonds and their presence percentage, obtained by the waveform analysis of C1s narrow spectra.

TABLE 2
Relationship between the oxidation time of polypropylene and kinds
of C bonds and its amount (%) determined by C1s curve fitting,

| Treatment time | | | | |
|---|---|---|---|---|
| (sec/cm²) | C—C, C—H | C—O—H | C═O | O—C═O |
| 0 | 96.6 | 2.9 | 0.1 | 0.3 |
| 2 | 93.2 | 4.7 | 2.3 | 0.7 |
| 3 | 93.4 | 7.3 | 3.0 | 2.0 |
| 4 | 90.2 | 8.6 | 3.5 | 2.5 |
| 5 | 84.2 | 13.0 | 6.4 | 4.3 |
| 6 | 84.9 | 12.3 | 5.2 | 4.6 |
| 7 | 84.3 | 16.0 | 5.8 | 5.8 |
| 10 | 82.5 | 17.5 | 6.7 | 6.0 |
| 20 | 81.1 | 18.9 | 8.8 | 7.3 |

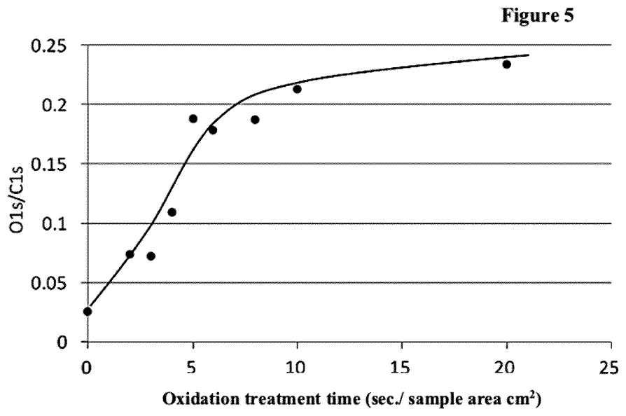

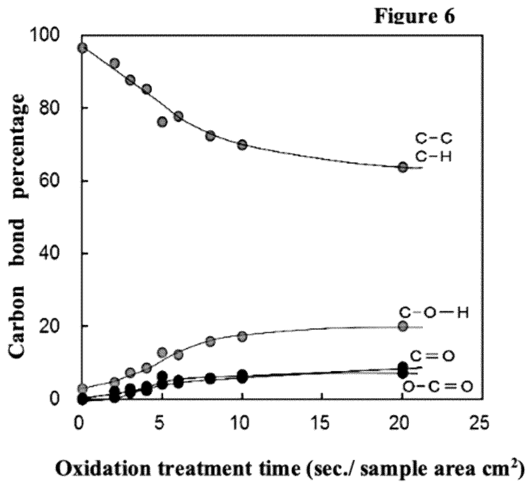

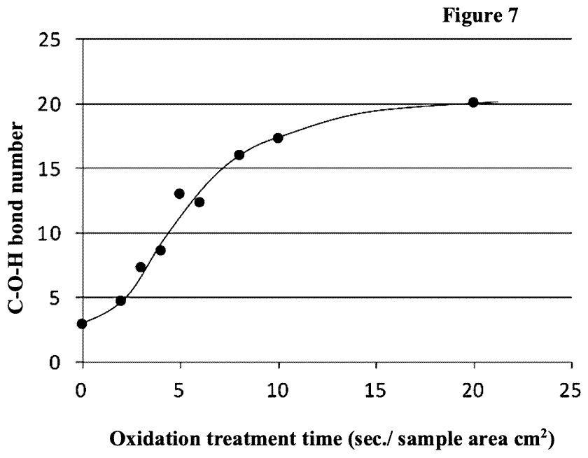

Based on these results, the relationship between the O/C atomic number ratio and oxidation treatment time in Table 1 is shown in FIG. 5, and the relationship between the percentage of each bond and oxidation treatment time in Table 2 is shown in FIG. 6. In addition, FIG. 7 shows an expanded plot of (C—O—H bond %)/(total carbon bond %).

It was confirmed that the O/C atomic number ratio, each of the numbers of C—O—H bonds, C═O bonds, and O═C—O bonds increase while the number of C—C and C—H bonds decreases, as the oxidation treatment time increases. Although the FTIR measurements in FIGS. 1 and 2 did not confirm the change in oxygen bonds with oxidation treatment time, it was found that the oxidation state could be confirmed by XPS measurements. From FIGS. 5, 6, and 7, it can be found that the increase in the amount of carbon-oxygen bonding becomes slower when the oxidation treatment time is 10 sec/cm² or longer.

### Example 2: XPS Measurement of Ozone-Oxidized Polyphenylene Sulfide Fiber

Polyphenylene sulfide (PPS) fiber (Torcon (registered trademark), Toray Corporation, Tokyo, Japan) was ozone-oxidized and XPS measurements were performed. An X-ray photoelectron spectrometer, K-Alpha (source: Al-Kα ray, extraction angle: 90°) manufactured by Thermo Fisher Scientific (USA) was used.

The results of XPS surface analysis of untreated and ozone-oxidized PPS fibers are shown in Table 3. It was confirmed that ozone oxidation treatment increases the O/C atomic number ratio and the C—O—H and O—C═O bonds in PPS fibers.

TABLE 3
Kinds of C bonds, their amounts (%) and atomic ratio
O1s/C1s determined by XPS surface analysis.

| Samples | C—C, C—H | C—O—H | C═O | O—C═O | O1s/C1s |
|---|---|---|---|---|---|
| untreated | 100 | 0 | 0 | 0 | 0.105 |
| oxidized | 95.4 | 4.14 | 0 | 0.5 | 0.149 |

The ozone oxidation treatment in this example was carried out according to the following procedure.

(Ozone oxidation treatment) The test piece is placed in a hard glass container (with a gas inlet and outlet) with a volume of 2 L, and an ozone generator (ON-1-2 type manufactured by Japan Ozone Corporation.) generates 2 g/h of ozone and a concentration of 40 g/m³ of oxygen containing ozone at a flow rate of 1000 ml/min was blown over the sample for 20 minutes. Ozone-free oxygen was then blown in for 10 minutes. The concentration of ozone was determined by the iodometric titration.

The analysis of XPS measurements of oxidation and treatment samples of polymethylpentene (PMP) resin sheets also showed that the oxidation treatment increased the O/C atomic ratio, the C—O—H bonds and O—C═O bonds. (PMP resin sheet) Thickness 0.5 mm, TPX (registered trademark) resin (Mitsui Chemicals Corporation, Tokyo, Japan).

### Example 3: Change in the Strength of Polypropylene Cloth Due to the Plasma Discharge Oxidation

Next, a polypropylene multifilament cloth (plain woven cloth made of threads twisted with microfilaments with a diameter of 0.25 mm: size: width 100 mm, length 200 mm, thickness 0.6 mm, basis weight 20 g/m²) is oxidized by the plasma discharge. The plasma discharge was performed for 15 seconds, 30 seconds, 60 seconds and 150 seconds, respectively, per 1 cm² area. The same plasma discharge apparatus as in Example 1 was used. A tensile strength test was performed after the oxidation treatment.

(Tensile strength test) Testing machine: a universal testing machine AUTOGRAPH AGS-H (Shimadzu Corporation, Kyoto, Japan) was used at tensile speed=10 mm/min, and a distance between specimen support points=600 mm.

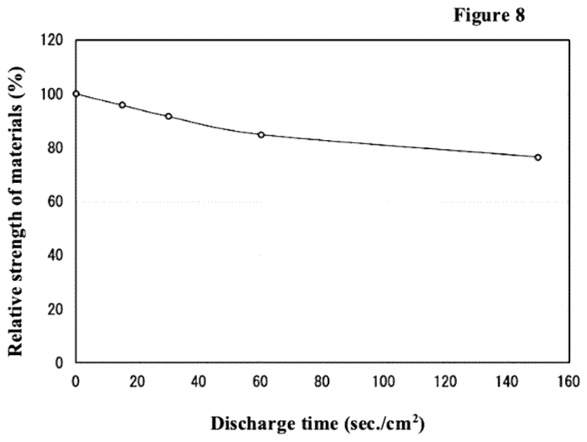

The results are shown in FIG. 8. The vertical axis is the material relative strength with the untreated material strength as 100%. The material strength decreases with increasing oxidation treatment time. In this case, the strength decrease may be significant because the sample is a thin fiber. When this fiber cloth with an oxidation time of less than 10 sec/cm² was used as a reinforcement material for composite materials, it was confirmed that the material strength increased. If the polypropylene material is in the form of a plate with a thickness of 0.1 mm or more, the decrease in the material strength due to the oxidation of 20 sec/cm² or less is negligible.

### Example 4: Reduction in Material Strength Due to Ozone Oxidation

Polypropylene multifilament cloth (plain weave cloth consisting of twisted microfilament yarns with a diameter of 0.25 mm: size 100 mm wide, 200 mm long, 0.6 mm thick, and 20 g/m² of thickness) was treated by the ozone oxidation. Then, the tensile strength was tested.

(Ozone oxidation treatment) The ozone oxidation treatment was done in the same manner as Example 2.

(Tensile strength test) The tensile strength test was done in the same manner as Example 3.

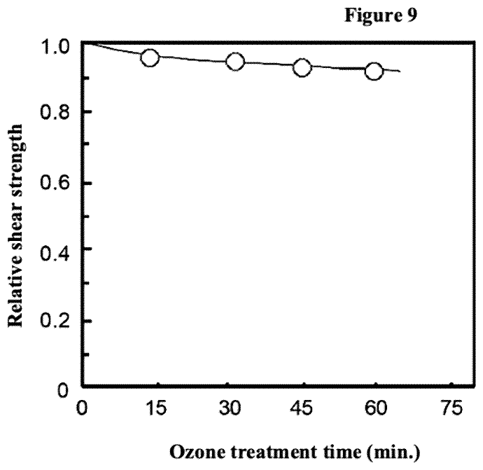

The results are shown in FIG. 9. Similar to the plasma oxidation treatment, the oxidation treatment for long time caused a decrease in the tensile strength. Compared to FIG. 8, the time axis in FIG. 9 is in minutes, so the decrease in the material strength due to the oxidation is milder for the ozone treatment than for the plasma treatment under the conditions of the performed ozone treatment.

### Example 5: DHM Treatment and XPS Measurement of Samples

The DHM (Durable Hydrophilic Modification) treatment is completed with the oxidized material, followed by a surface coating step. The XPS measurement was performed on the plasma-oxidized samples (irradiation time=5 sec./cm²) after the surface coating step. The results are shown in Table 4. It was observed that the O1s/C1s ratio and the percentage of each functional group containing oxygen increased for each sample compared to the plasma-treated sample only.

TABLE 4
Kinds of carbon bonding and their percentage
(%) and the ratio oxygen number/carbon number
in XPS analysis for each DHM-treated material

| | Percentage of each bond (%) | | | | |
|---|---|---|---|---|---|
| Samples | C—C, C—H | C—O—H | C═O | O—C═O | O1s/C1s |
| PP board | 72.9 | 17.3 | 3.23 | 6.58 | 0.300 |
| PPS fiber | 82.2 | 12.8 | 0 | 4.98 | 0.344 |
| PMP board | 66.7 | 26.4 | 3.65 | 2.93 | 0.324 |

The oxidation treatment and coating steps in the DHM treatment in this example were performed according to the following procedures.

(Oxidation treatment) The specimens were oxidized by the atmospheric pressure plasma treatment method of Example 1 at an irradiation dose of 10 sec/cm², and then washed with methanol and water.

(Coating step) A reaction solution A was made by mixing a volume ratio of 400 water, 100 methanol, 1 acrylic acid, 0.1 methyl methacrylate, and 0.1 methyl methacrylate. The oxidation treated material was placed in a flat tray, the reaction solution A was added to cover the treated material to a depth of about 5 mm, the tray was covered (not sealed) with a hard glass plate 0.5 mm thick, and the UV irradiation* was performed from a distance of 100 mm for 20 minutes. After removing the material and washing with methanol, the treated material was thoroughly rinsed with hot water and dried to complete the treatment. The weight gain of the sample after the treatment was less than 0.1% of the weight of the sample before treatment. *Ultraviolet irradiation: A high-pressure mercury vapor lamp (product name H1500L, manufactured by Toshiba Lighting and Technology Corporation.; total length 360 mm, emission length 200 mm, lamp voltage 315 V, lamp power 1500 W) is irradiated on the samples without a filter. To avoid heating, a strong wind is blown between the lamp and the specimen using a homemade “cooling fan with a slit in the blower.

### Example 6: A Bond Strength Test to Search for the Best Oxidation Treatment for DHM Treatment

In order to find out “the appropriate oxidation time for the oxidation step” in DHM treatment effective for improving adhesion, the samples of polypropylene (PP) and aluminum plates treated with DHM with different oxidation times were made, and the tensile shear strength of the samples were measured.

PP plates (size 10 mm×80 mm, thickness 1.0 mm) were DHM treated with the oxidation and coating steps according to the following procedure.

(Oxidation treatment) The oxidation was carried out by the plasma discharge in the same manner as Example 1. The oxidation treatment time ranged from 0 to 20 s/cm².

(Coating step) The coating step was carried out by the same manner as Example 5.

The adhesion and tensile shear strength measurements were performed as follows.

(Bonding tensile shear strength test) Treated PP plates and aluminum plates (0.2 mm thick) were bonded using an epoxy adhesive, Bond-Quick 5 (Konishi, Corporation., Osaka, Japan), according to the manufacturer's instruction. That is, after mixing approximately equal amounts of liquid A (main agent; epoxy resin) and liquid B (hardener; polythiol) on an adhesive mixing sheet, the mixture was uniformly applied to a polypropylene sample so that the bonding area was 10 mm×10 mm, and an aluminum plate was placed over it (the adhesive amount was approximately 80 mg). The adhesive sample was placed between plastic plates and a 1 kg weight was placed on it and left for 36 hours under room temperature. A tensile test was conducted under the following conditions to measure the tensile shear strength (N). (Equipment used) Tabletop load testing machine FTN1-13A (Aicoh Engineering Corporation., Japan), tensile speed: 20 mm/min, “4 cm PP plate/1 cm adhesive portion/1 cm aluminum plate” in the space between the holding fixture, and the PP plate. The tensile test was performed with the holding fixture holding both ends of the PP plate and aluminum plate.

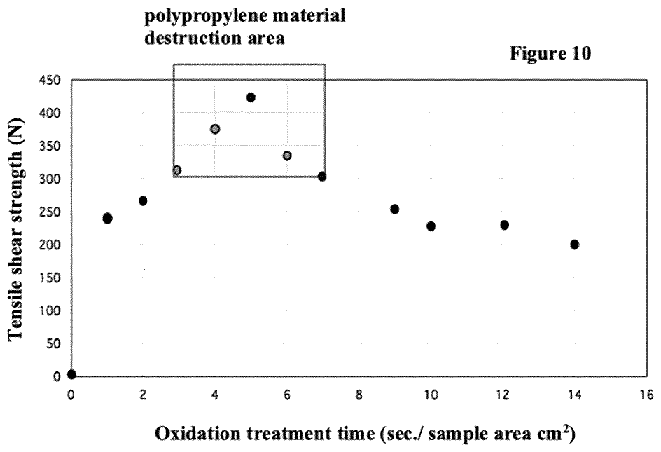

The results are shown in FIG. 10. In the figure, the squares indicate areas where the material breakdown was observed during the adhesion test. The modified specimens with oxidation treatments of 3-7 sec/cm² showed the material breakdown of PP, which indicates the highest adhesive strength. The surface modified samples with oxidation treatments of 3, 4, 6, and 7 sec/cm² exhibited the material failure of the PP board at the strength values in FIG. 10. On the other hand, the modified sample with an oxidation treatment of 5 sec/cm² did not peel off the adhesive portion, and the PP board stretched, making the measurement impossible at a stress of 425 N. The surface modified sample with an oxidation treatment of 5 sec/cm² did not peel off the adhesive portion, but stretched the PP board. The most favorable adhesion was observed for the oxidized sample at 5 sec/cm², as the PP board was stretched. At oxidation times before and after oxidation treatment 3-7 sec/cm², the bond strength of the modified sample is lower, but the bond strength is higher than the bonded sample of the untreated sample.

From the results of XPS measurement and adhesion strength test of polypropylene, materials with oxidation levels that exhibit an O/C atomic number ratio of about 0.03 to 0.30 and a C—O bonding ratio of about 3 to 20% when measured by XPS, or materials with oxidation levels that exhibit an increase in the O atomic number ratio (the percentage of O atoms among atoms excluding hydrogen) of about 0.01 to 0.15 or an increase in the C—O—H bonding ratio of about 1 to 15% when measured by XPS compared with untreated materials, are particularly suitable. Materials at oxidation levels that exhibit an increase in O atom number fraction (the percentage of O atoms among atoms excluding hydrogen) of about 0.01 to 0.15% or an increase in C—O—H bonding ratio of about 1 to 15% compared to untreated materials when measured by XPS are considered particularly suitable for use in improving the adhesive properties of the material. The reduction in the strength of the material is almost 0% in the case of plates and 2-3% less in the case of fine fibers. The fine fibers confirm that the material strength increases when the modified fibers are used in composites. Therefore, the decrease in material strength at similar oxidation levels should not be considered a problem. The same observation was confirmed for materials other than polypropylene.

### Example 7: Durability of Treatment

It is said that the plasma-treated silicon rubber sheets lose their adhesion property unless they are adhered immediately after the treatment. Therefore, the plasma-treated and DHM-treated silicone rubber sheets were left for a specified time before being bonded to an aluminum plate to compare their adhesive tensile shear strength. For comparison, an untreated silicone rubber sheet was also bonded to an aluminum plate. The results are shown in Table 5. The plasma-treated silicone rubber sheet must be bonded within about 1 hour or else adhesion is lost. The bonding strength was considerably lower than that of the DHM-treated sample.

TABLE 5
Adhesion of silicone rubber and aluminum board;
adhesive = poly(cyano acrylate) adhesive

| | Elapsed time after the treatment (hour) | | | | |
|---|---|---|---|---|---|
| | 0 | 1 | 3 | 5 | 24 |
| Samples | Adhesive tensile shear strength | | | | |
| untreated silicone | 3.0 | 3.0 | 3.0 | 3.0 | 3.0 |
| rubber sheet | | | | | |
| oxidation treated | 19 | 15 | 3.0 | 3.0 | 2.0 |
| silicone rubber sheet | | | | | |
| DHM treated silicone | 54 | 54 | 54 | 54 | 54 |
| rubber sheet | | | | | |

The oxidation and DHM treatments in this example were performed according to the following procedures.

(Oxidation treatment) Plasma treatment; Real Plasma APJ-500 (Kasuga Denki Corporation.; high-frequency power supply AGI-B202) was used in air at atmospheric pressure, with output power=300 W, 200 V, sample-to-electrode distance=10 mm, and 5 sec/cm² (1 sec irradiation per 1 cm² of sample area). The degree of oxidation was the same as Example 6.

(DHM treatment) The following coating step was performed on the material oxidized by the above plasma treatment of silicone rubber sheet. The oxidized material was placed in a reaction solution and heated at 80° C. for 10 minutes. Specifically, by volume ratio, a solution of 800 water, 200 methanol, 1 hydroxyethyl methacrylate (HEMA), 0.1 methyl methacrylate (MMA), and 10 mg azobisisobutyronitrile (AIBN) was added to the reaction solution. The material was placed in the reaction solution and heated at 80° C. for 10 minutes. The material was removed from the reaction mixture, washed with methanol, then boiled with water and dried.

(Fiber-Reinforced Plastic (FRP) Composite Material Using Thermosetting Resin (Epoxy Resin) as Base Material)

### Example 8: Composite Material of Polypropylene Fiber and Epoxy Resin

FRP of untreated or modified polypropylene (PP) fiber/epoxy resin was prepared. The bending strength of each sample was measured. Results are shown in Table 6. The material strength of the fabricated FRPs increased, even if there was a slight decrease in the fiber strength due to the modification.

TABLE 6

| Fiber | Basic resin | Bending strength (MPa) |
|---|---|---|
| untreated PP | epoxy resin | 38 |
| DHM treated PP | | 60 |

The materials used in this example were as follows.

(Polypropylene (PP) fiber) Polypropylene plain-woven fabric, specific gravity=20 g/m², constituent thread: multifilament (diameter 0.5 mm), diameter of monofilament fiber=30 μm.

(Epoxy resin) Main agent: liquid epoxy resin, curing agent: diamine-based curing agent: GM-6800 (Blenny Giken Corporation., Gunma, Japan)

The DHM treatment, FRP manufacturing method, and test method in this example were as follows.

(DHM processing) It was carried out in the same way as the DHM treatment of Example 5, except that the oxidation time is 5 seconds/cm².

(Manufacturing Method of PP Fiber/Epoxy Resin FRP)

Hand lay-up method: Six layers of PP cloth were layered in a stainless steel mold (concave mold), epoxy resin mixed with a hardening agent was poured in, and left to stand for a day to solidify. The size of the molding portion (concave mold) of the mold was 80 mm in length and 10 mm in width; manufactured according to JIS standards. Size of fabricated FRP=10 mm×80 mm×2.6 mm.

(Tensile shear strength test of materials) They were measured using the universal testing machine AUTOGRAPH AGS-H (Shimadzu Corporation., Kyoto, Japan).

(Three-point bending strength test of materials (JIS-K7171 compliant)) It was done with the same tester as above. Bending speed was 5 mm/min. and the distance between fulcrums was 40 mm.

### Example 9: Composite Material of UHMWPE Fiber and Epoxy Resin

Untreated or modified ultra-high-molecular-weight polyethylene (UHMWPE) fiber/epoxy resin FRP was produced. The bending strength of each sample was measured. Results are shown in Table 7. As with the PP fiber/epoxy resin FRP, even though the fiber strength decreased slightly due to the modification, the material strength increased when it was made into FRP.

TABLE 7

| UHMWPE fiber | Basic resin | Bending strength (MPa) |
|---|---|---|
| untreated | epoxy resin | 69 |
| DHM treated | | 118 |

The materials used in this example are as follows.

Ultra-high-molecular-weight polyethylene (UHMWPE) fiber; multifilament yarn (0.62 mm in diameter) consisting of monofilaments (diameter=30 μm): trade name=Izanas, provided by Toyobo Corporation., Osaka, Japan.

The oxidation treatment and coating steps in the DHM treatment in this example and the FRP manufacturing process were as follows. The three-point bending strength test is the same as in Example 8.

(Oxidation treatment) The ozone oxidation method in Example 2 was used. The oxidation time was 15 minutes.

(Coating Step) The coating step was performed in the same manner as in Example 5.

(FRP manufacturing method of UHMWPE fiber/epoxy resin) Hand lay-up method: 40 threads were placed parallel to each other in a JIS-compliant mold (concave mold), and 10 g of epoxy resin mixed with a hardener was poured into the mold, which was left to solidify for 1 day. Molded FRP size=10 mm×80 mm×2.6 mm.

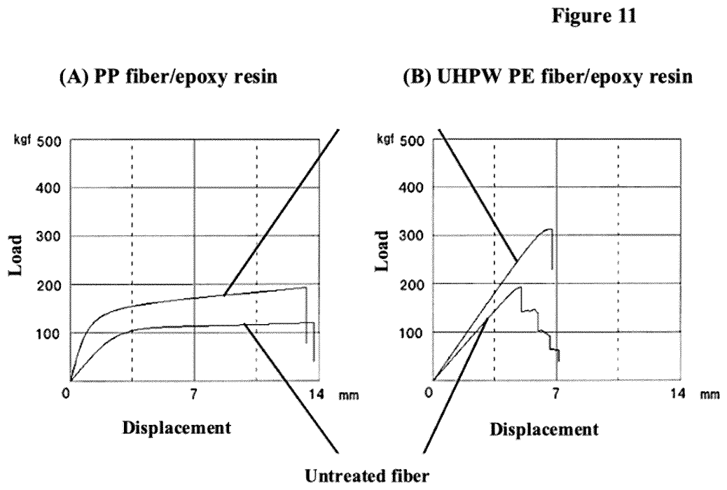

FIG. 11 shows the “load-displacement curves” for the three-point bending strength tests corresponding to Tables 6 and 7; (A) PP fiber/epoxy resin and (B) UHMWPE fiber/epoxy resin. Untreated PP fiber/epoxy resin and untreated UHMWPE fiber/epoxy resin split in two in the three-point bend test, while DHM-treated PP fiber/epoxy resin and DHM-treated UHMWPE fiber/epoxy resin remained bent in a “U” shape after the three-point bend strength test. The fiber/resin interface adhesion was excellent. This indicates a high adhesion at the fiber/resin interface.

(Composite Materials Using Thermoplastic Resin as Base Material)

Various materials treated with surface modification according to the method of the present disclosure were tested by preparing composite materials with various materials. In the case of composite materials made from untreated or oxidized fibers or films and base resin, the fibers or films were pulled out from the resin in a three-point bending strength test, resulting in material failure. On the other hand, for composites made from DHM-treated fibers or films and various resins, it was observed that material failure occurred when the fibers or films did not pull out from the resin and the material was cut while maintaining adhesion.

### Example 10: PET Fiber and Polypropylene Resin Composite Material

Fiber composite materials were prepared by combining PET fiber (polyethylene terephthalate; plain weave fabric (NBC Meshtec, Tokyo), Japan) and polypropylene (PP) resin. The same three-point bending test as above was then performed. The results are shown in Table 8.

TABLE 8

| | Bending | Bending |
|---|---|---|
| Samples | strength (MPa) | modulus (MPa) |
| untreated PE fiber/untreated PP fiber | 24 | 730 |
| oxidation treated PET fiber/ | 26 | 780 |
| oxidation treated PP fiber | | |
| DHM treated PET fiber/DHM | 30 | 870 |
| treated PP fiber | | |

The oxidation treatment, DHM treatment, and composite manufacturing process in this example were as follows. Three-point bending strength test is the same as in Example 8.

(Oxidation treatment) Plasma treatment; PET fiber and PP resin were treated in the same way as Example 6.

(DHM treatment) The coating step of Example 7 was performed on the oxidized material.

(Composite manufacturing method) The mold is sprayed with a mold release agent. Next, polypropylene resin and PET fiber are packed alternately. The mold is then fixed to a compact heat press, As-One HC300-01 at 240° C. for 10 minutes without pressure, and then for another 5 minutes with 2 MPa pressure applied. After that, return to room temperature and remove the composite material specimen from the mold. The mold was designed according to JIS standards. The sample size was 60 mm long, 10 mm wide, and approximately 2 mm thick.

### Example 11: Carbon Fiber and Polypropylene Resin Composite Material

A high-strength fiber composite material was prepared from carbon fiber and polypropylene (PP) resin.

Fiber composite materials with different fiber contents were prepared from carbon fiber (CF) and PP film, and three-point bending tests of the fiber composite materials were conducted. Carbon fibers were obtained from Mitsubishi Chemical products. The results are shown in Table 9.

TABLE 9
Bending strength (MPa) of samples

| | Fiber content (wt. %) | | | |
|---|---|---|---|---|
| | 10 | 20 | 30 | 40 |
| Samples | Bending strength (MPa) | | | |
| untreated CF/untreated PP | 56 | 63 | 42 | 42 |
| oxidation treated CF/oxidation treated PP | 57 | 62 | 71 | 47 |
| DHM treated CF/DHM treated PP | 75 | 107 | 97 | 69 |

The oxidation treatment, DHM treatment, and composite manufacturing process in this example were as follows. The three-point bending strength test was the same as in Example 8.

(Oxidation treatment) Plasma treatment: plasma oxidation of carbon fiber (with resin) and polypropylene film was performed in the same way as Example 1.

(DHM treatment) The coating step of Example 7 was carried out for the oxidized materials.

(Composite material manufacturing method) Ten sheets of PP film 0.3 mm thick and a bundle of carbon fiber filaments are packed into a mold. The mold is fixed to a compact heat press, an As-One H300-01 at 240° C. for 10 minutes without pressure, and then pressure of 2 MPa is applied for 5 minutes. After cooling to room temperature, the specimen was removed from the mold.

Fiber composite materials made from surface-modified fibers and resins exhibited high bending strength. Fiber composites made from surface modified fibers and resins showed maximum strength at a small fiber content of 20%.

### Example 12: Carbon Fiber and Amide Resin Composite

A high-strength fiber composite material was prepared from carbon fiber and amide resin.

Fiber composite materials were prepared from surface-modified carbon fiber (CF) and polyamide (PA6) resin, and the three-point bending test of the fiber composite materials was made. The results are shown in Table 10.

TABLE 10
Bending strength of carbon fiber/polyamide resin composites

| | | Fiber | Bending |
|---|---|---|---|
| | | content | strength |
| No. | Samples | (wt. %) | (MPa) |
| 1 | PA6 resin | 0 | 37 |
| 2 | untreated CF/untreated PA6 | 7.6 | 60 |
| 3 | untreated CF/oxidation treated PA6 | 8.3 | 60 |
| 4 | oxidation treated CF/oxidation treated PA6 | 9.3 | 51 |
| 5 | untreated CF/DHM treated PA6 | 7.9 | 81 |
| 6 | DHM treated CF/DHM treated PA6 | 8.1 | 95 |

The materials used in this example are as follows. Carbon fiber: a product of Mitsubishi Chemical Corporation, Tokyo, Japan. Polyamide resin: PA6=nylon-6 pellets manufactured by Sigma-Aldrich Corporation.

The oxidation treatment and DHM treatment in this example were as follows. The three-point bending strength test is the same as in Example 8.

(Oxidation treatment) Carbon fiber (with resin) and PA6 were treated in the same way as the ozone treatment in Example 2.

(DHM treatment of CF) The coating step of Example 7 was performed for oxidized materials.

(DHM treatment of PA6) A reaction solution A was made by mixing a volume ratio of 400 water, 400 methanol, and 10 hydrophilic monomer (vinyl pyrrolidone) *. The material for treatments was placed in a flat tray, and then, the reaction solution A was added to cover the material to a depth of about 5 mm, the tray was covered (not sealed) with a hard glass plate 0.5 mm thick, and the UV irradiation was performed from a distance of 100 mm for 10 minutes. The material was removed and washed with methanol. Then, the treated material was coated with a hydrophilic polymer solution B**, and the coated material was dried and washed in boiling water. *Vinylpyrrolidone; 1-vinyl-2-pyrrolidone, Fujifilm Wako Pure Chemicals Corporation, Tokyo, Japan, product code 228-01285.**Aqueous hydrophilic polymer solution B; 1 weight % aqueous solution of a mixture of polyvinylpyrrolidone (PVP)*** and carboxymethylcellulose (CMC)**** (mixture weight ratio 10:1).***PVP: average molecular weight 40,000, K30 Fujifilm Wako Pure Chemicals Corporation, Tokyo, Japan: product code 161-03105.****CMC: sodium carboxymethylcellulose (Fujifilm Wako Pure Chemicals Corporation, Tokyo, Japan, product code 4987481229082).

### Example 13: Composite Material of Polyimide Film and Polyester Resin

Composite materials were similarly prepared from polyimide (PI) film and polyester resin, and the three-point bending test of the composite materials was done. The results are shown in Table 11.

TABLE 11
Bending strength of polyimide film/polyester
resin composite materials

| Sample | | | Film content | Bending strength |
|---|---|---|---|---|
| No. | Fiber | Resin | (%) | (MPa) |
| 1 | untreated | polyester | 0 | 40 |
| | polyimide | | | |
| 2 | untreated | | 9.4 | 66 |
| | polyimide | | | |
| 3 | oxidation treated | | 12 | 120 |
| | polyimide | | | |
| 4 | DHM treated | | 8.0 | 88 |
| | polyimide | | | |
| 5 | DHM treated | | 12 | 200 |
| | polyimide | | | |

The materials used in this example are as follows.

(Polyimide (PI) film) Product of As-One Corporation, Polyimide Film Kapton®, model number 3-1966-07, 0.25 mm thick.

(Polyester resin) Product of PROST Corporation, unsaturated polyester resin for FRP repair, low shrinkage type, with curing agent, for general lamination (non-paraffinic).

The oxidation treatment and DHM treatment in this example were as follows. The three-point bending strength test is the same as in Example 8.

(Oxidation treatment) PI film was polished 5 times in one direction only with water-resistant abrasive paper (600 grit, water-resistant paper; a product of BELSTAR Abrasive Industries STARCKE (Germany)). Next, the ozone treatment of Example 2 was performed.

(DHM treatment) For the above oxidation treated materials, the coating step was performed as follows. The post-polymerization by electron beam irradiation was carried out as follows. The polished ozone-treated material was irradiated with electron beams (EB) for 5 seconds/cm² (per sample area) at an acceleration voltage of 80 kV and an irradiation dose of 250 kGy by an electron beam irradiation device (EC90 manufactured by Iwasaki Electric Corporation.). The material was taken out and coated with a monomer solution (a mixture of 10 HEMA, 1 MMA, 10 water, and 4 methanol, by volume) and heated at 60° C. for 1 minute. The treated material was taken out, washed in water, and dried.

### Example 14: Composite Material of High-Strength Fiber Cloth and Vulcanized Black Rubber

T-type peel tests were performed on fiber/rubber composite materials made by placing untreated or treated high-strength aramid fiber cloth between pre-cured vulcanized black rubber and then curing the cloth. The results are shown in Table 12.

TABLE 12
T-type peel tests of high-strength fiber cloth/vulcanized
black rubber composite samples

| | | | Peeling | Destructive |
|---|---|---|---|---|
| Sample | Material A | Material B | strength N/m | style |
| 1 | untreated aramid | vulcanized | 16 | interface |
| | fiber cloth | black rubber | | detachment |
| 2 | plasma treated | | 17 | interface |
| | aramid fiber cloth | | | detachment |
| 3 | DHM treated | | 20 | rubber |
| | aramid fiber cloth | | | destruction |

The materials used in this example are as follows. (Aramid fiber cloth) A product of Esco Corporation, Japan, size 1.0×1.0 m: Kevlar fiber 100 fabric EA911AV-1, thickness 0.5 mm.

(Vulcanized black rubber) Supplied by Sourier Corporation, Japan.

The oxidation treatment, DHM treatment, and composite manufacturing process in this example were as follows.

(Oxidation treatment) Chemical reaction treatment; an aqueous solution was made by mixing 10 ml of sodium hypochlorite solution (Fujifilm Wako Pure Chemicals Corporation, Tokyo, Japan, product code 197-02206, effective chlorine: 5.0+%) and 100 ml of water by volume. The sodium hypochlorite solution was placed in a glass container and a material to be treated was added in it. Then, the container was gradually heated, and 0.2 ml of acetic acid was added in it. After boiling the reaction mixture for 3 minutes, the container was allowed to cool to room temperature, and then the material was removed. The material was rinsed in water and dried naturally. The oxidation of the material was confirmed by XPS measurement.

(DHM treatment) The following coating step was performed on the above oxidized material. The monomer solution was a mixture of acrylic acid (AA) 10, methacrylic acid (MA) 1, water 10, and methanol 4 by volume. The coating step was carried out in the same way as Example 7.

(Composite material manufacturing method) An aramid fiber sample was clamped between soft black rubber with vulcanizing agent added, and a silicone rubber plate was placed on top of the sample and pressurized with a 1 kg weight for 24 hours. The fiber content was set at 20%.

The T-type peel test was performed as follows.
(1) Fiber cloth sample size: 10 mm wide and 100 mm long.
(2) The cloth was clipped between two pieces of black rubber, letting out 10 mm of the end of the cloth, and it was molded by heating. The adhesive area between the cloth and rubber is 10 mm×90 mm.
(3) About 10 mm of one end of the black rubber (the side with the cloth sticking out) was peeled off by hand.
(4) The peeled end of the rubber and the overhanging portion of the cloth were each attached to a jig for a tension test, and pulled at a tension speed of 10 mm/min.

The surface modification of the present disclosure provides a high-strength composite material with an unprecedentedly close-contact fiber/resin interface.

### INDUSTRIAL APPLICABILITY

The present disclosure provides surface-modified materials of superior strength and provides a high-strength composite material, which provides benefits in various industries such as automobiles, aircraft, medical devices, electronic devices, etc.

1. A method for surface modifying a material, comprising,
(1) the step of oxidizing said material, and
(2) the step of surface coating said oxidation treated material;
the method, wherein said oxidation treatment includes the steps of,
(i) the oxidation treatment is performed such that the (C—O bonds)/(total carbon bonds) % within a depth of 10 nm of the surface of said material as measured by X-ray photoelectron spectroscopy (XPS) increases by about 1 to 20% from before the oxidation treatment, or
(ii) the oxidation treatment is performed so that the percentage of (C—O bonds)/(total carbon bonds) within a depth of 10 nm of the surface of said material, as measured by X-ray photoelectron spectroscopy (XPS), is about 5-15%,
(iii) the method is performed such that the O/C atomic number ratio within a depth of 10 nm of the surface of said material as measured by X-ray photoelectron spectroscopy (XPS) is about 0.03 to 0.2,
wherein the step of surface coating comprises subjecting the oxidation treated material to
(a) grafting a hydrophilic vinyl monomer,
(b) grafting a hydrophilic monomer and applying a hydrophilic polymer, or
(c) grafting the vinyl ester monomer and subjecting to hydrolysis.

2. The method according to claim 1, wherein the step of oxidizing said material is performed such that the (C—O bonds)/(total carbon bonds) % within a depth of 10 nm of the surface of said material, as measured by X-ray photoelectron spectroscopy (XPS), increases by about 1.5˜15% from before the oxidation treatment.

3. The method according to claim 1, wherein the step of oxidizing said material is performed such that the (C—O bonds)/(total carbon bonds) % within a depth of 10 nm of the surface of said material, as measured by X-ray photoelectron spectroscopy (XPS), increases by about 2 to 10% from before the oxidation treatment.

4. The method according to claim 1, wherein the step of oxidation treatment of the material is carried out such that the (C—O bonds)/(total carbon bonds) % within a depth of 10 nm of the surface of the material, as measured by X-ray photoelectron spectroscopy (XPS), is about 5-15%.

5. The method according to claim 1, wherein the step of oxidation treatment of said material is performed such that the O/C atomic number ratio within a depth of 10 nm of the surface of said material is about 0.03 to 0.2 when measured by X-ray photoelectron spectroscopy (XPS).

6. The method for producing an adhesive material, comprising the step of surface modifying said material by the method of claim 1 and the step of interfacially adhering or bonding said material to the second material.

7. The method according to claim 6, wherein said step of interfacial adhesion or bonding is carried out under conditions wherein an adhesive is present between said material and the second material.

8. The method according to claim 6, wherein the step of interfacial adhesion or bonding the material and the second material is carried out, after about 1 hour has elapsed from the step of surface modifying the material.

9. The method according to claim 6, wherein compared to adhesive materials made from materials prepared under the same conditions except without the step of oxidation treatment described above, it results in an improvement in shear strength of 200 N or more, when the tensile test of a specimen of said surface-modified material of 10 mm width and 1 mm thickness bonded to an aluminum plate of 0.2 mm thickness so that the bonded area is 10 mm×10 mm, at a speed of 20 mm/min and a distance of 60 mm between support points.

10-14. (canceled)

15. The method according to claim 1, comprising the step of washing the material to be oxidized prior to said step of oxidation treatment.

16. The method according to claim 1, wherein said step of oxidizing includes oxidizing by a treatment selected from the group consisting of plasma treatment, ozone treatment, UV irradiation treatment, corona discharge treatment, high pressure discharge treatment and chemical oxidation.

17-18. (canceled)

19. A surface modified material produced by the method of claim 1.

20. An adhesive material produced by the method of claim 6.

21-24. (canceled)

25. A method for surface modifying a material, comprising,
(1) the step of oxidizing said material, and
(2) the step of surface coating said oxidation treated material;
the method, wherein said oxidation treatment includes the steps of,
(i) the oxidation treatment is performed such that the (C—O bonds)/(total carbon bonds) % within a depth of 10 nm of the surface of said material as measured by X-ray photoelectron spectroscopy (XPS) increases by about 1 to 20% from before the oxidation treatment, or
(ii) the oxidation treatment is performed so that the percentage of (C—O bonds)/(total carbon bonds) within a depth of 10 nm of the surface of said material, as measured by X-ray photoelectron spectroscopy (XPS), is about 5-15%,
(iii) the method is performed such that the O/C atomic number ratio within a depth of 10 nm of the surface of said material as measured by X-ray photoelectron spectroscopy (XPS) is about 0.03 to 0.2,
wherein the increase in weight of the oxidation treated material by the step of surface coating is less than about 5%.

26. A use of the surface modified material of claim 19 in parts of transportation vehicles (automobiles, aircraft, etc.), parts of medical instruments, dental materials, building materials, surface coatings, or laminated materials, etc.

27. A method for producing a composite material, comprising the step of surface modifying said material by the method of claim 1, and the step of combining said material with the second material to form a composite material.

28. A use of the adhesive material of claim 20 in parts of transportation vehicles (automobiles, aircraft, etc.), parts of medical instruments, dental materials, building materials, surface coatings, or laminated materials, etc.

29. A use of the composite material of claim 27 in parts of transportation vehicles (automobiles, aircraft, etc.), parts of medical instruments, dental materials, building materials, surface coatings, or laminated materials, etc.
